(19) United States
(12) Patent Application Publication
(10) Pub. No.: US 2022/0089449 A1
(43) Pub. Date: Mar. 24, 2022

(54) METHOD FOR PRODUCING CHLOROSILANES

(71) Applicant: Wacker Chemie AG, Munich (DE)

(72) Inventors: Karl-Heinz Rimböck, Heldenstein (DE); Andreas Hirschmann, Ering (DE)

(73) Assignee: Wacker Chemie AG, Munich (DE)

(21) Appl. No.: 17/309,805

(22) PCT Filed: Dec. 19, 2018
(86) PCT No.: PCT/EP2018/086007

§ 371 Date: Jun. 18, 2021

(51) Int. Cl. C01B 33/107

(52) U.S. Cl. CPC C01B 33/1071

(57) ABSTRACT

The present disclosure relates to a process for producing chlorosilanes by reaction of a reaction gas containing hydrogen, tetrachlorosilane and optionally at least one further chlorosilane in a reactor and optionally in the presence of a catalyst. The chlorosilanes have the general formula HₙSiCl₄₋ₙ, and the reactor design is described by an index K1, the composition of the reaction gas before entry into the reactor is described by an index K2, and the reaction conditions are described by an index K3.

The invention relates to a process for producing chlorosilanes by reaction of a reaction gas containing tetrachlorosilane, hydrogen and optionally at least one further chlorosilane in a reactor, optionally in the presence of a catalyst, wherein the chlorosilanes have the general formula HₙSiCl₄₋ₙ where n=1 to 4, characterized in that the reactor design is described by an index K1, the composition of the reaction gas before entry into the reactor is described by an index K2 and the reaction conditions are described by an index K3, wherein K1 has a value of 66 to 2300, K2 has a value of 13 to 250, K3 has a value of 7 to 1470.

The production of polycrystalline silicon as a starting material for the manufacture of chips or solar cells is typically effected by decomposition of its volatile halogen compounds, in particular trichlorosilane (TCS, HSiCl₃).

Polycrystalline silicon (polysilicon) may be produced in the form of rods by the Siemens process, wherein polysilicon is deposited on heated filament rods in a reactor. A mixture of TCS and hydrogen is typically employed as process gas. Alternatively, polysilicon granulate may be produced in a fluidized bed reactor. This comprises fluidizing the silicon particles in a fluidized bed using a gas flow, wherein said fluidized bed is heated to high temperatures via a heating apparatus. Addition of a silicon-containing reaction gas such as TCS causes a pyrolysis reaction to take place at the hot particle surface, thus causing the particles to increase in diameter.

The production of chlorosilanes, in particular TCS, may be carried out essentially by three processes which are based on the following reactions (cf. WO2010/028878A1 and WO2016/198264A1):

Si+3HCl-->SiHCl₃+H₂+byproducts (1)

Si+3SiCl₄+2H₂-->4SiHCl₃+byproducts (2)

SiCl₄+H₂-->SiHCl₃+HCl+byproducts (3)

Byproducts generated may include further halosilanes, for example monochlorosilane (H₃SiCl), dichlorosilane (H₂SiCl₂), silicon tetrachloride (STC, SiCl₄) and di- and oligosilanes.

Impurities such as hydrocarbons, organochlorosilanes and metal chlorides may also be constituents of the byproducts. Production of high-purity TCS therefore typically includes a subsequent distillation.

The hydrochlorination (HC) according to reaction (1) makes it possible to produce chlorosilanes from metallurgical silicon (Si_{mg}) by addition of hydrogen chloride (HCl) in a fluidized bed reactor, wherein the reaction proceeds exothermically. This generally affords TCS and STC as the main products.

A further option for producing chlorosilanes, in particular TCS, is the thermal conversion of STC and hydrogen in the gas phase in the presence or absence of a catalyst.

The low temperature conversion (LTC) according to reaction (2) is a weakly endothermic process and is typically performed in the presence of a catalyst (for example copper-containing catalysts or catalyst mixtures). The LTC may be carried out in a fluidized bed reactor in the presence of Si_{mg} under high pressure (0.5 to 5 MPa) at temperatures between 400° C. and 700° C. An uncatalyzed reaction mode is possible using Si_{mg} and/or by addition of HCl to the reaction gas. However, other product distributions may result and/or lower TCS selectivities may be achieved than in the catalyzed variant.

The high temperature conversion (HTC) according to reaction (3) is an endothermic process. This process is typically carried out in a reactor under high pressure at temperatures between 600° C. and 1200° C. The reaction may be performed under catalysis.

The known processes are in principle costly and energy intensive. The required energy input which is generally effected by electric means represents a significant cost factor. The operative performance (expressed for example by the TCS selectivity-weighted productivity, the formation of little in the way of high-boiling byproducts or energy efficiency) of the HTC depends decisively on the adjustable reaction parameters. A continuous process mode further requires that the reaction components STC and hydrogen are introduced into the reactor under the reaction conditions and this is associated with considerable technical complexity. Against this backdrop it is important to realize the highest possible productivity (amount of chlorosilanes formed per unit time and reaction volume) and the highest possible selectivity based on the desired target product (typically TCS) (TCS selectivity-weighted productivity).

The production of chlorosilanes by HTC is generally a dynamic process. For the most efficient possible performance and constant optimization of the HTC it is necessary to understand and visualize the underlying dynamics. This generally requires methods having a high temporal resolution for process monitoring.

It is known to determine the composition in a product mixture from HTC in a personnel-intensive laboratory method by analysis of withdrawn samples (off-/at-line measurement). However, said analysis always takes place with a time delay and thus in the best case provides a point-like, retrospective snapshot of a discrete operating state of a reactor (reactors for HTC are usually designated as high-temperature converters or converters). However, if for example product gas streams of a plurality of converters are combined in one condensation sector and only one sample of this condensate mixture is withdrawn it is not possible to draw concrete conclusions about the operating conditions of the individual reactors on the basis of the analytical results.

In order to be able to measure the composition of a product mixture from HTC in high temporal resolution it is possible to employ (preferably at each individual reactor) process analyzers in the gas and/or condensate stream, for example process gas chromatographs (on-/in-line and/or noninvasive measurement). However, in principle the disadvantage of this is the limited number of employable instruments due to the high thermal stress and the aggressive chemical environment. The generally high capital and maintenance costs are a further cost factor.

In order to identify discrete operating states of High-temperature converters it is possible in principle to make use of various process analytical methods which may be categorized as follows (W.-D. Hergeth, On-Line Monitoring of Chemical Reactions: Ullmann's Encyclopedia of Industrial Chemistry, Wiley: Weinheim, Germany 2006).

| Category | Sampling | Sample transport | Analysis |
|---|---|---|---|
| off-line | manual | to remote | automated/ |
| | | laboratory | manual |
| at-line | discontinuous | to local analytical | automated/ |
| | manual | instrument | manual |
| on-line | automated | integrated | automated |
| in-line | integrated | no transport | automated |
| noninvasive | no contact | no transport | automated |

The disadvantages of process analyzers may be circumvented by a model-based methodology based on so-called soft sensors (virtual sensors). Soft sensors make use of continuously determined measured data of operating parameters that are essential to the operation of the process (for example temperatures, pressures, volume flows, fill levels, power outputs, mass flows, valve positions etc.). This makes it possible for example to predict concentrations of main products and byproducts.

Soft sensors are based on mathematical equations and are dependency simulations of representative measured values to a target value. In other words soft sensors show dependencies of correlating measured values and lead to a target parameter. The target parameter is thus not measured directly but rather is determined on the basis of measured values correlating therewith. Applied to the HTC this means that for example the TCS content or the TCS selectivity are not determined with real measurement sensors (for example a process gas chromatograph) but rather may be calculated via correlations between operating parameters.

Mathematical equations for soft sensors may be obtained by fully empirical modeling (for example based on a transformed power law model) by semi-empirical modeling (for example based on kinetic equations for describing a reaction rate) or by fundamental modeling (for example based on fundamental equations of flow mechanics and kinetics). The mathematical equations may be derived using process simulation programs (for example OpenFOAM, ANSYS or Barracuda) or regression programs (for example Excel VBA, MATLAB oder Maple).

The present invention has for its object to improve the economy of the production of chlorosilanes by HTC.

This object is achieved by a process for producing chlorosilanes by reaction of a reaction gas containing hydrogen, STC and optionally at least one further chlorosilane in a reactor (converter), optionally in the presence of a catalyst, wherein the chlorosilanes have the general formula HₙSiCl₄₋ₙ where n=1 to 4.

The reactor design is described by a dimensionless index K1, wherein

$$K 1 = κ \cdot ϑ \cdot \frac{( {A}_{tot , Δ T -} - {A}_{tot , Δ T +} ) \cdot {l}_{tot , gas}}{{V}_{R , eff}} , where \\ ϑ = temperature floor , \\ κ = area factor , \\ {A}_{tot , Δ T -} = cooled heat exchanger surface area in the reactor [ {m}^{2} ] , \\ {A}_{tot , Δ T +} = heated heat exchanger surface area in the reactor [ {m}^{2} ] , \\ {V}_{R , eff} = effective reactor volume [ {m}^{3} ] and \\ {l}_{tot , gas} = length of gas path in reactor [ m ] . \qquad ( equation 1 )$$

The composition of the reaction gas before entry into the reactor is described by a dimensionless index K2, wherein

$$K 2 = {R}_{tot , gas} \cdot \frac{{\dot{V}}_{n , STC}}{{\dot{V}}_{n , H 2}} \cdot 100 , where \\ {\dot{V}}_{n , STC} = volume flow of STC [ {Nm}^{3} \text{/} h ] , \\ {\dot{V}}_{n , H 2} = volume flow of hydrogen [ {Nm}^{3} \text{/} h ] and \\ {R}_{tot , gas} = purity of the reaction gas [ \% ] . \qquad ( equation 4 )$$

The reaction conditions are described by a dimensionless index K3, wherein

$$K 3 = {W}_{el} \cdot \frac{{v}_{F}}{{V}_{R , eff}} \cdot \frac{{ρ}_{F}}{{p}_{diff}^{2}} \cdot {10}^{10} , where \\ {W}_{el} = electrical power [ kg * {m}^{2} \text{/} {s}^{2} ] , \\ {v}_{F} = kinematic viscosity of the fluid [ {m}^{2} \text{/} s ] , \\ {ρ}_{F} = fluid density [ kg \text{/} {m}^{3} ] and \\ {p}_{diff} = differential pressure of reaction gas [ kg \text{/} m * {s}^{2} ] . \qquad ( equation 5 )$$

In the process K1 is specified a value of 66 to 2300, K2 a value of 13 to 250 and K3 a value of 7 to 1470. The productivity of the process is particularly high within these ranges.

The use of physical and virtual methods of process monitoring made it possible to identify new correlations in the HTC which make it possible to describe the HTC via the three indices K1, K2 and K3 in such a way that the process is operable in particularly economic fashion through the choice of certain parameter settings and combinations thereof. The process according to the invention allows for integrated, predictive process control in the context of “Advanced Process Control (APC)” for the HTC. If the HTC is performed in the inventive ranges for K1, K2 and K3, especially via process control systems (preferably APC controllers), the highest possible economic efficiency is achieved. In an integrated system for production of silicon products (for example polysilicon of various quality grades) integration of the process allows the production sequence to be optimized and production costs to be reduced.

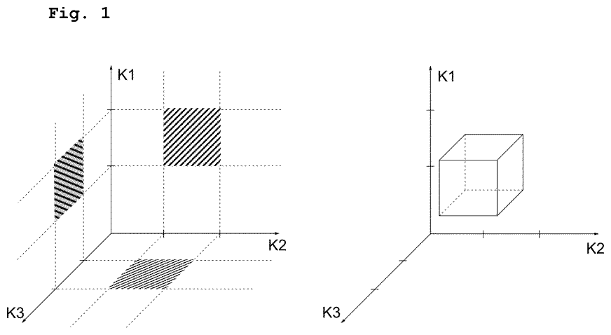

When plotted in a Cartesian coordinate system the ranges for the indices K1, K2 and K3 span a three-dimensional space which represents a particularly economic operating range for the HTC. Such an operating range is shown schematically in FIG. 1. The process according to the invention especially also considerably simplifies the configuration of new reactors for the HTC (high temperature converter).

Soft sensors additionally allow performance parameters such as for example TCS selectivity to be shown as a function of K1, K2 and K3. The performance data thus determined in high temporal resolution can be passed on to a process control means, in particular a model-predictive control means, as a manipulated variable. This makes it possible to operate the process in economically optimized fashion.

In a preferred embodiment of the process K1 has a value of 95 to 1375, particularly preferably of 640 to 780.

K2 preferably has a value of 20 to 189, particularly preferably of 45 to 85.

K3 preferably has a value of 24 to 866, particularly preferably of 40 to 300.

K1—Reactor Design

The index K1 relates parameters of reactor geometry to one another. One example of a conversion reactor is apparent from U.S. Pat. No. 4,536,642. Equation 1 relates the effective volume of the reactor interior V_{R,eff}, the sum of all cooled heat exchanger surface areas in the reactor A_{tot,ΔT-}, the sum of all heated heat exchanger surface areas in the reactor A_{tot,ΔT+} and the length of the gas path in the reactor to the area factor x and the temperature factor ∂.

V_{R, eff} corresponds to the total volume of the reactor interior minus all internals. V_{R,eff} is by preference 2 to 15 m³, preferably 4 to 9 m³.

The geometry of the reactor interior is determined not only by general constructional features such as height, width, shape (for example cylinder or cone) but also by internals arranged in the interior. The internals may be in particular heat exchanger units, stiffening planes, feeds (conduits) for introducing the reaction gas and apparatuses for distributing and/or deflecting the reaction gas (for example gas distributor plates).

A_{tot,ΔT-} and A_{tot,ΔT+} are described as heat-specific surface areas. A_{tot,ΔT+} encompasses the surface areas by means of which energy is supplied to the reactor. These are in particular heating surface areas (for example surface areas of resistance heaters, heat exchanger surface areas supplying energy/heat to the system). A_{tot,ΔT-} encompasses the surface areas by means of which heat/energy is dissipated. These are in particular surface areas of heat exchangers and surface areas of the reactor wall which dissipate heat outwards.

The cooled heat exchanger surface area in the reactor A_{tot,ΔT-} is preferably 320 to 1450 m², in particular 450 to 1320 m². The heated heat exchanger surface area A_{tot,ΔT+} is preferably 90 to 420 m², in particular 120 to 360 m². A_{tot,ΔT-} is normally greater than A_{tot,ΔT+} on account of the reactor wall.

The length of the gas path (from the gas inlet into the reactor up to the gas outlet) in or through the reactor is preferably 5 to 70 m, in particular 25 to 37 m.

In principle the measurement of all objects (for example diameter of the interior, perimeter of the internals, heat-specific surface areas) may be carried out using for example laser measurements/3-D scans (for example ZEISS COMET L3D 2). These dimensions are typically also discernible from the reactor manufacturer's literature and/or with reference to their design drawings or may be calculated on the basis thereof.

The area factor x is the quotient of active/catalytically active surface areas and passive surface areas with which the reaction gas may come into contact. x is thus a ratio of all surface areas involved in the reaction and is derived from equation 2:

$$κ = \frac{{A}_{active} + {A}_{cat}}{{A}_{passive}} , where \\ {A}_{active} = surface area having an effect on byproduct formation [ {m}^{2} ] , \\ {A}_{cat} = surface area having a catalytic effect on byproducts [ {m}^{2} ] and \\ {A}_{passive} = surface area without effect on byproduct formation [ {m}^{2} ] . \qquad ( equation 2 )$$

Surface areas passive for the HTC are preferred in principle since they do not negatively affect the reaction. Passive surface areas are for example surface areas which have been provided with a protective layer, for example a SiC layer, and are therefore inert not only with respect to product formation but also with respect to byproduct formation. The protective layer can also prevent corrosion. For example, uncoated graphite surface areas may be attacked by hydrogen to liberate methane. Further byproducts can result from the methane.

Surface area having a catalytic effect is to be understood here as meaning in particular the surface areas which, while having a positive effect on product formation, unselectively favor both product formation and byproduct formation. The catalytic surface areas are in particular coated with a catalytically active layer.

Active surface areas are surface areas which favor the formation of byproducts. These may be for example uncoated graphite surface areas.

As a result of the normally complex designs for reactor internals (for example cylindrical components for gas distribution, optionally provided with bores and sharp edges; push-fit and screw-fit pieces) it is fundamentally not possible for all surface areas to be in the form of passive surface areas. While the proportion of passive surface areas may be increased at considerable cost, this is to the detriment of the economy of the process as a whole. There are additionally surface areas which should be in the form of active surface areas. In the case of components of resistance heaters for example, intentional erosion during the process is advantageous since this means that the mass and thus the temperature profile continuously changes. This results in an intentional, local deviation and thus a distribution of the graphite attack. Without this distribution geographically very limited damage could occur and the reactor could fail prematurely. It is preferable when not more than 20% of all surface areas in the reactor (surface areas with which the reaction gas comes into contact) are in the form of active and/or catalytic surface areas. It is further preferable when at least 20% of all surface areas in the reactor are in the form of passive surface areas.

The optionally present catalyst may be in the form of a coating on a surface area in the reactor interior.

The catalyst comprises preferably one or more elements from the group comprising Fe, Cr, Ni, Co, Mn, W, Mo, V, P, As, Sb, Bi, O, S, Se, Te, Ti, Zr, C, Ge, Sn, Rh, Ru, Pt, Pd, Pb, Cu, Zn, Cd, Mg, Ca, Sr, Ba, B, Al, Y and Cl. The catalyst is particularly preferably selected from the group comprising Fe, Ni, Cu, Cr, Co, Rh, Ru, Pt, Pd, Zn and mixtures thereof. The catalytically active elements may be present in the coating in a certain proportion. The elements may be present in the coating in oxidic or metallic form, as chlorides, as silicides or in other metallurgical phases for example. The coating may be in particular high density tungsten alloys comprising the alloy constituents Ni, Cu, Fe and Mo.

The sum of the surface areas Aₚₐₛₛᵢᵥₑ, A_{active}, A_{cat} is preferably 800 to 2900 m², in particular 980 to 2650 m².

The temperature factor ∂ from equation 1 accounts for the temperatures in the and/or at the reactor and is derived from equation 3:

$$ϑ = \frac{{T}_{gas , out} - {T}_{gas , in}}{{T}_{gas , control}} , where \\ {T}_{gas , out} = gas outlet temperature [ ° C . ] , \\ {T}_{gas , in} = gas inlet temperature [ ° C . ] and \\ {T}_{gas , control} = control temperature [ ° C . ] . \\ {T}_{gas , in} is preferable 80 ° C . to 160 ° C . , in particular 100 ° C . to 160 ° C . \\ {T}_{gas , out} is preferable 80 ° C . to 400 ° C . , in particular 200 ° C . to 320 ° C . \\ {T}_{gas , control} is preferable 800 ° C . to 1200 ° C . , in particular 900 ° C . to 1000 ° C . \qquad [ equation 3 ]$$

Temperature measurement is carried out in the gas stream (for example with a PT100 element) in the conduit directly upstream of the reactor inlet and directly downstream of the reactor outlet. T_{gas,control} is measured in the reaction space as described for example in U.S. Pat. No. 4,536,642.

In principle a large difference between T_{gas,in} and T_{gas,out} also means that more additional energy must also be supplied. The economy of the process worsens with increasing difference.

K2—Composition of the Reaction Gas

The dimensionless index K2 describes via equation 4 the composition of the reaction gas before entry into the reactor. In addition to the purity of the reaction gas R_{tot,gas}, K2 is in particular determined by the ratio of the feed quantity of STC \dot{V}_{n,STC} (volume flow of STC) and the feed quantity of hydrogen \dot{V}_{n,H2} (volume flow of H₂). Purity of the reaction gas R_{tot,gas} before entry into the reactor relates in particular to the primary components STC and H₂ and also to any further chlorosilane present.

The volume flow of the STC \dot{V}_{n,STC} is preferably 600 to 5800 Nm³/h, in particular 1100 to 4500 Nm³/h. The volume flow of the H₂ \dot{V}_{n,H2} is preferably 750 to 13 500 Nm³/h, in particular 1350 to 9000 Nm³/h. Determination of the volume flow may be carried out in the conduit upstream of the reactor inlet for example with a Coriolis flowmeter.

The reaction gas may further contain one or more components selected from the group comprising HₙSiCl₄₋ₙ (n=1, 3), HₘCl₆₋ₘSi₂ (m=2 to 6), H_{q}Cl_{6-q}Si₂O (q=0 to 4), (CH₃)ₓH_{y}SiCl_{4-x-y} (x=0 to 4, y=0 or 1), CH₄, C₂H₆, C₄H₁₀, C₅H₁₂, C₆H₁₄, CO, CO₂, O₂, Cl₂, N₂. It may be preferable for R_{tot,gas} to relate only to the primary components H₂ and STC.

It is preferable when the further chlorosilane is dichlorosilane and/or disilane of general formula HₘCl₆₋ₘSi₂ where m=0 to 6.

The reaction gas preferably has a content of STC and H₂ and any further chlorosilane present of at least 97%, preferably at least 98%, particularly preferably at least 99%. The reported percentages correspond to the purity R_{tot,gas}

The composition of the reaction gas is typically determined before supplying to the reactor via Raman and infrared spectroscopy and also gas chromatography. This may be carried out either via samples withdrawn in the manner of spot checks and subsequent “offline analyses” or else via “online” analytical instruments integrated into the system.

K3—Reaction Conditions

The index K3 relates to one another via equation 5 the generally most important parameters of the HTC. Contained therein are the kinematic viscosity of the fluid VF, the fluid density ρ_{F}, the effective reactor volume V_{R,eff}, the differential pressure of the reaction gas p_{diff} between the reactor inlet and the reactor outlet and the electrical power Wₑₗ.

The fluid density ρ_{F} and the kinematic viscosity ν_{F} may be determined by simulations of (phase) equilibrium states using process engineering software. Fluid is generally to be understood as meaning the gaseous reaction mixture in the reactor interior. The simulations are typically based on adapted phase equilibria which for varying physical parameters (for example p and T) draw on actually measured compositions of the reaction mixture both in the gas phase and in the liquid phase. This simulation model may be validated using actual operating states/parameters and thus allows specification of operating optima in respect of the parameters ρ_{F} and ν_{F}.

Determination of phase equilibria may be carried out using a measurement apparatus for example (for example modified Rock and Sieg recirculation apparatus, for example MSK Baraton Typ 690, MSK Instruments). Variation of physical influencing variables such as pressure and temperature bring about changes of state for a substance mixture. The different states are subsequently analyzed and the component composition is determined, for example with a gas chromatograph. Computer-aided modeling can be used to adapt equations of state to describe phase equilibria. The data are transferred into the process engineering software programs so that phase equilibria can be calculated.

Kinematic viscosity is a measure of momentum transfer perpendicular to the flow direction in a moving fluid. Kinematic viscosity ν_{F} may be described via dynamic viscosity and fluid density. Density may be approximated for example via the Rackett equation for liquids and via an equation of state, for example Peng-Robinson, for gases. Measurement of density may be carried out with a digital density measuring instrument (for example DMA 58, Anton Paar) using the torsion pendulum method (eigenfrequency measurement).

The kinematic viscosity ν_{F} is preferably in a range from 2.5*10⁻⁴ to 5.1*10⁻⁴ m²/s, in particular 2.8*10⁻⁴ to 4.7*10⁻⁴ m²/s. The fluid density ρ_{F} is preferably 19.5 to 28 kg/m³, in particular 21.5 to 26 kg/m³.

The electrical energy Wₑₗ is preferably 450,000 to 3,700,000 kg*m²/s², in particular 500,000 to 3,200,000 kg*m²/s². Wₑₗ is generally introduced into the reactor exclusively via resistance heaters. These are in turn dimensioned according to the reactor size and the amount of the reaction gas to be converted (to be heated).

The differential pressure p_{diff} of the reaction gas is preferably 0.45 to 3 MPa, in particular 0.6 to 2.6 MPa. To determine p_{diffthe} pressure is measured both in the feed conduit for the reaction gas and in the discharge conduit for the offgas for example with a manometer. p_{diff} is derived from the difference.

The absolute pressure in the reactor is preferably 4 to 16 MPa.

The process is preferably integrated into an integrated system for production of polysilicon. The integrated system preferably comprises the following processes: production of TCS by the process according to the invention, purification of the produced TCS to afford semiconductor-quality TCS, deposition of polysilicon, preferably by the Siemens process or as a granulate.

### EXAMPLES

In order to apply the findings and correlations to productivity in the production of chlorosilanes and to define the ranges for the indices K1, K2 and K3 (operating ranges) detailed investigations on continuously operated high temperature converters of different sizes were performed.

Various experiments V were performed (table 1: V1 to V13) and the parameters underlying the indices were varied in turn to define a general, optimal operating range for the HTC. The selected parameter combinations of K1, K2 and K3 were evaluated and the optimal range defined based on conversion [kg/(Nm³)], i.e. the amount of TCS [kg] produced per hour based on the amount of STC [Nm³] used in the reactor. A conversion of 15.3 kg/Nm³ is considered normal to good productivity. At a conversion above this value productivity is considered optimal. Conversion is therefore normalized by a factor of 15.3 kg/Nm³ to indicate productivity. An optimal productivity is accordingly above 100%. V1 to V13 are shown as representatives of a multiplicity of experiments performed for determination of optimal ranges.

TABLE 1

| | Productivity [%] | K1 | K2 | K3 |
|---|---|---|---|---|
| V1 | 98.9 | 25 | 11 | 13 |
| V2 | 102.2 | 640 | 52 | 120 |
| V3 | 101.4 | 900 | 130 | 85 |
| V4 | 100.1 | 350 | 32 | 85 |
| V5 | 102.5 | 730 | 60 | 145 |
| V6 | 94.2 | 3000 | 284 | 3 |
| V7 | 98.5 | 50 | 18 | 85 |
| V8 | 97.4 | 10 | 420 | 600 |
| V9 | 100.4 | 650 | 53 | 60 |
| V10 | 101.8 | 750 | 80 | 290 |
| V11 | 99.7 | 750 | 13 | 1490 |
| V12 | 96.9 | 2505 | 40 | 800 |
| V13 | 96.2 | 600 | 80 | 5 |

The experiments verify that an elevated/optimal chlorosilane production can be accomplished by HTC provided that the process is kept in the claimed ranges of the indices K1, K2 and K3.

1-18. (canceled)

19. A process for producing chlorosilanes, comprising: reacting a reaction gas containing hydrogen, tetrachlorosilane and optionally at least one further chlorosilane in a reactor, optionally in the presence of a catalyst, wherein the chlorosilanes have the general formula HₙSiCl₄₋ₙ where n=1 to 3, and
wherein the reactor design is described by an index
$$K 1 = κ \cdot ϑ \cdot \frac{( {A}_{tot , Δ T -} - {A}_{tot , Δ T +} ) \cdot {l}_{tot , gas}}{{V}_{R , eff}} ;$$
wherein ∂ is a
$$temperature factor = \frac{{T}_{gas , out} - {T}_{gas , in}}{{T}_{gas , control}} ;$$
wherein T_{gas,out} is a gas outlet temperature [° C.];
wherein T_{gas,in} is a gas inlet temperature [° C.]; and
wherein T_{gas,control} is a control temperature [° C.];
wherein x is an
$$area factor = \frac{{A}_{active} + {A}_{cat}}{{A}_{passive}} ;$$
wherein A_{active} is a surface area having an effect on byproduct formation [m²];
wherein A_{cat} is a surface area having a catalytic effect on byproducts [m²];
wherein Aₚₐₛₛᵢᵥₑ is a surface area without effect on byproduct formation [m²];
wherein A_{tot,ΔT-} is a cooled heat exchanger surface area in the reactor [m²];
wherein A_{tot,ΔT+} is a heated heat exchanger surface area in the reactor [m²];
wherein V_{R,eff} is an effective reactor volume [m³];
wherein l_{tot,gas} is a length of gas path in reactor [m];
wherein A_{tot,ΔT-} is 320 to 1450 m²;
wherein A_{tot,ΔT+} is 90 to 420 m²;
wherein V_{R,eff} is 2 to 15 m³; and
wherein l_{tot,gas} is 5 to 70 m;
wherein the composition of the reaction gas before entry into the reactor is described by an index
$$K 2 = {R}_{tot , gas} \cdot \frac{{\dot{V}}_{n , STC}}{{\dot{V}}_{n , H 2}} \cdot 100 ;$$
wherein \dot{V}_{n,STC} is a volume flow of STC [Nm³/h];
wherein \dot{V}_{n,H2} is a volume flow of hydrogen [Nm³/h];
wherein R_{tot,gas} is a purity of the reaction gas [%];
wherein \dot{V}_{n,STC} is 600 to 5800 Nm³/h; and
wherein \dot{V}_{n,H2} is 750 to 13,500 Nm³/h;
the reaction conditions are described by an index
$$K 3 = {W}_{el} \cdot \frac{{v}_{F}}{{V}_{R , eff}} \cdot \frac{{ρ}_{F}}{{p}_{diff}^{2}} \cdot {10}^{10} ;$$
wherein Wₑₗ is an electrical power [kg*m²/s²];
wherein ν_{F} is a kinematic viscosity of the fluid [m²/s];
wherein ρ_{F} is a fluid density [kg/m³];
wherein p_{diff} is a differential pressure of reaction gas [kg/m*s²];
wherein Wₑₗ is 450,000 to 3,700,000 kg*m²/s²;
wherein ν_{F} is 2.5*10⁻⁴ to 5.1*10⁻⁴ m²/s;
wherein ρ_{F} is 19.5 to 28 kg/m³; and
wherein p_{diff} is 4.5*10⁵ to 3*10⁶ kg/m*s²; and
wherein K1 has a value of 66 to 2300, K2 has a value of 13 to 250 and K3 has a value of 7 to 1470.

20. The process of claim 19, wherein K1 has a value of 95 to 1375 or preferably of 640 to 780.

21. The process of claim 19, wherein K2 has a value of 20 to 189 or preferably of 45 to 85.

22. The process of claim 19, wherein K3 has a value of 24 to 866 or preferably of 40 to 300.

23. The process of claim 19, wherein the effective reactor volume V_{R,eff} is 4 to 9 m³.

24. The process of claim 19, wherein the heated heat exchanger surface area in the reactor A_{tot,ΔT+} is 120 to 360 m².

25. The process of claim 19, wherein the cooled heat exchanger surface area in the reactor A_{tot,ΔT-} is 450 to 1320 m².

26. The process of claim 19, wherein the length of the gas path in the reactor l_{tot,gas} is 25 to 37 m.

27. The process of claim 19, wherein the catalyst is in the form of a coating on a surface area in the reactor interior.

28. The process of claim 19, wherein the volume flow of the silicon tetrachloride \dot{V}_{n,STC} is 1,100 to 4,500 Nm³/h.

29. The process of claim 19, wherein the volume flow of the hydrogen \dot{V}_{n,H2} is 1,350 to 9,000 Nm³/h.

30. The process of claim 19, wherein the reaction gas has a content of silicon tetrachloride, hydrogen and any further chlorosilane present of at least 97%, preferably at least 98%, or particularly preferably at least 99%.

31. The process of claim 19, wherein the further chlorosilane is disilane of the general formula HₘCl₆₋ₘSi₂ (m=0 to 5) and/or dichlorosilane.

32. The process of claim 19, wherein the kinematic viscosity ν_{F} is 2.8*10⁻⁴ to 4.7*10⁻⁴ m²/s.

33. The process of claim 19, wherein the fluid density ρ_{F} is 21.5 to 26 kg/m³.

34. The process of claim 19, wherein the electrical energy Wₑₗ is 500,000 to 3,200,000 kg*m²/s².

35. The process of claim 19, wherein the differential pressure of the reaction gas p_{diff} is 6*10⁵ to 2.6*10⁶ kg/m*s².
